(19) United States
(12) Patent Application Publication
(10) Pub. No.: US 2010/0110100 A1
(43) Pub. Date: May 6, 2010

(54) Method and System For Extracting and Applying Colour Schemes Across Domains

(76) Inventors: Krishnapillai Anandasivam, Singapore (SG); Christiane English, Singapore (SG)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/309,625

(22) PCT Filed: Jul. 25, 2006
(86) PCT No.: PCT/SG2006/000207

§ 371 Date: Nov. 4, 2009

(51) Int. Cl. G09G 5/02

(52) U.S. Cl. 345/593

(57) ABSTRACT

A method and system for applying a colour scheme from a source domain to an application domain, wherein the source domain is graphically different from the application domain. The method comprises mapping colours present in the source domain onto a reference colour space; mapping colours present in an object displayable in the application domain onto the reference colour space; defining two or more discontinuous source regions in the reference colour space, the discontinuous source regions approximating a distribution of colours present in the source domain in the reference colour space; defining two or more discontinuous application regions in the reference colour space, the discontinuous application regions approximating a distribution of colours present in the object in the reference colour space; selecting one or more colours from the reference colour space which represent the respective discontinuous source and application regions; varying the colours representing the discontinuous application regions based on the colours representing the discontinuous source regions; and displaying the first object in the application domain utilising the varied colours representing the discontinuous application regions.

### FIELD OF INVENTION

The present invention relates to a method and system for extracting and applying colour schemes from one domain to the another, and to a data storage medium having stored thereon computer code means for instructing a computer to execute a method of applying a colour scheme from one domain to another.

### BACKGROUND

At present, selection of colour schemes in computer graphics design, photo editing, product design, apparel designs, advertising, etc. for aesthetic purposes still depends largely on the creativity and skill of the designer. Considerations for quality selection involve choosing and applying colours that can evoke specific emotive responses on viewers.

There are currently many systems for the measurement for colour. For instance one can select colours and create colour schemes in computer image editing programs using the common RGB (Red, Green, Blue), HSB (Hue, Saturation, Brightness) or Commission Internationale de l'Eclairage (CIE) Lab colour spaces. A disadvantage for such programs is that designers are forced to synthesis the emotive aspects of colour from a combination of pre-set colours. Whereas, it is widely accepted that colour schemes are derived from inspiration arising out of human experience.

Various methods for the selection of colour schemes have been proposed. The most popular is the Colour Wheel which describes the disposition of colours in a circular pattern. Other methods to create colour palettes for a design have also been offered. Some are based on colour theory using three primary colours (E.g. trichromacy theory) and a colour wheel, other colour systems provide perception based uniformly spaced colour samples (E.g. Munsell Book of colour or the Natural Colour System) or provide advice given by colour trends (E.g. Pantone, other expert advice on colour coordination etc.). All the methods aim to limit the colour range available to users from over 10 million visible colours to ranges of not more than 2500 samples. Although limitation makes selection an easier task and sometimes improves the quality of the selection, it inevitably reduces the freedom and flexibility of selection. As the relationship between colour and emotive response varies from culture to culture, and is also affected by the context in which colour is viewed, observing a colour formulaic approach to colour selection is fundamentally unsuitable.

To determine the emotive aspects of colour, one can rely on perception data i.e. feedback contributed by a sample population on the feelings associated to certain colours, rely on colour combinations for emotive qualities suggested by renowned individuals, or manually sort out compilations of images (e.g. “Mood Boards”) to find an appropriate image for representing a desired colour expression. This is usually a tedious process that requires a lot of time and effort to achieve the desired colour schemes. Most colour schemes are derived out of inspiration arising out of visual experience. Often the inspiration is derived from a totally different domain to the domain in which it is applied. The purpose of selecting colours schemes is to render to the object of application some of the visual and therefore emotive qualities of the inspirational source.

Current methods for colour scheme selection are time consuming and the control over the existing colour schemes is limited. Also, statistical feedback, expert suggestions or image database on emotive responses are hardly readily available. Existing software are also insufficient for expert users and difficult for novice users.

A need therefore exists to provide a method and system for extracting and applying colour schemes that addresses at least one of the above-mentioned problems.

### SUMMARY

In accordance with a first aspect of the present invention there is provided a method of applying a colour scheme from a source domain to an application domain, wherein the source domain is graphically different from the application domain, the method comprising mapping colours present in the source domain onto a reference colour space; mapping colours present in an object displayable in the application domain onto the reference colour space; defining two or more discontinuous source regions in the reference colour space, the discontinuous source regions approximating a distribution of colours present in the source domain in the reference colour space; defining two or more discontinuous application regions in the reference colour space, the discontinuous application regions approximating a distribution of colours present in the object in the reference colour space; selecting one or more colours from the reference colour space which represent the respective discontinuous source and application regions; varying the colours representing the discontinuous application regions based on the colours representing the discontinuous source regions; and displaying the first object in the application domain utilising the varied colours representing the discontinuous application regions.

The method may comprise the step of moving the discontinuous source or application regions, or both, in the reference colour space prior to selecting the colours representing the respective discontinuous source or application regions, or both.

The moving of the discontinuous source or application regions, or both, may be based on technical colour manipulation commands or mathematically interpreted linguistic colour manipulation commands.

The varying of the colours representing the discontinuous application regions based on the colours representing the discontinuous source regions may also be based on the distribution of colour in the source or application domain, or both.

The reference colour space may comprise a perceptionally continuous colour space.

The perceptionally continuous colour space may comprise CIE Lab colour space.

The method may further comprise determining respective interrelationships between the different discontinuous source regions and between the different discontinuous application regions.

The method may further comprise manipulating said interrelationships.

The manipulating of said interrelationships may comprise one or more of a group consisting of expanding, contracting, elongating, translating and scaling.

The method may further comprise storing said interrelationships.

The method may comprise mapping colours present in respective ones of a plurality of source domains onto the reference colour space and defining two or more discontinuous source regions in the reference colour space, the discontinuous source regions approximating a distribution of the colours present in the plurality of source domains in the reference colour space.

Relative positions of some of the discontinuous source regions may be maintained while relative positions of others of the discontinuous source regions are relaxed in the reference plane.

The method may comprise deciding to either adhere strictly to relative positions of the discontinuous application regions or to relax the relative positions of the discontinuous application regions in order to achieve a closer chromatic representation of the source domain.

The mapping of colours present in the source domain onto the reference colour space may comprise defining one or more colour regions in the reference colour space based on fitness values of respective color points with regard to a criterion and manipulating the colour regions according to mathematical operations associated with imprecise linguistic operators.

Manipulating the colour regions may comprise manipulating a size, a shape, or both of the colour region.

Manipulating the colour regions may comprise moving the colour regions within the reference colour space.

Attributes of the colour points of the colour regions may be transformed during the moving of the colour regions, thereby changing the individual colours associated with the respective colour points.

One or more of the colour regions may be defined based on thresholding the fitness values of the respective colour points.

The colour regions and the fitness values of the respective colour points may be created by letting an evaluator arrange the colours in an ordered set from a set of given colors.

The color regions the fitness values of the respective colour points may be created based on fitness values assigned by a number of evaluators.

The method may comprise extracting colours from an image, using manual selection of colours or using image processing techniques, and determining the fitness values of the respective colours.

The method may comprise displaying colours associated with a random selection of respective colour points with a selected distance from a specified colour in the reference colour space.

The selected distance from the specified colour in the reference colour space may be adjustable.

The defined colour regions may be saved in a retrievable format for further use.

In accordance with a second aspect of the present invention there is provided a system for applying a colour scheme from a source domain to an application domain, wherein the source domain is graphically different from the application domain, the system comprising a mapping unit for mapping colours present in the source domain onto a reference colour space and for mapping colours present in an object displayable in the application domain onto the reference colour space; a processor unit for defining two or more discontinuous source regions in the reference colour space, the discontinuous source regions approximating a distribution of colours present in the source domain in the reference colour space, and for defining two or more discontinuous application regions in the reference colour space, the discontinuous application regions approximating a distribution of colours present in the object in the reference colour space; a selector unit for selecting one or more colours from the reference colour space which represent the respective discontinuous source and application regions; wherein the processor unit varies the colours representing the discontinuous application regions based on the colours representing the discontinuous source regions; and a display unit for displaying the first object in the application domain utilising the varied colours representing the discontinuous application regions.

The processor unit may move the discontinuous source or application regions, or both, in the reference colour space prior to the selector unit selecting the colours representing the respective discontinuous source or application regions, or both.

The moving of the discontinuous source or application regions, or both, may be based on technical colour manipulation commands or mathematically interpreted linguistic colour manipulation commands.

The varying of the colours representing the discontinuous application regions based on the colours representing the discontinuous source regions may also be based on the distribution of colour in the source or application domain, or both.

The reference colour space may comprise a perceptionally continuous colour space.

The perceptionally continuous colour space may comprise CIE Lab colour space.

The processor unit may further determine respective interrelationships between the different discontinuous source regions and between the different discontinuous application regions.

The processor unit may manipulate said interrelationships.

The manipulating of said interrelationships may comprise one or more of a group consisting of expanding, contracting, elongating, translating and scaling.

The system may further comprise a database for storing said interrelationships.

The mapping unit may map colours present in respective ones of a plurality of source domains onto the reference colour space and the processor unit defines two or more discontinuous source regions in the reference colour space, the discontinuous source regions approximating a distribution of the colours present in the plurality of source domains in the reference colour space.

The processor unit may maintain relative positions of some of the discontinuous source regions while relaxing relative positions of others of the discontinuous source regions in the reference plane.

The processor unit may operate either in a state of adhering strictly to relative positions of the discontinuous application regions or in a state of relaxing the relative positions of the discontinuous application regions in order to achieve a closer chromatic representation of the source domain.

The mapping of colours present in the source domain onto the reference colour space may comprise defining one or more colour regions in the reference colour space based on fitness values of respective color points with regard to a criterion and manipulating the colour regions according to mathematical operations associated with imprecise linguistic operators.

Manipulating the colour regions may comprise manipulating a size, a shape, or both of the colour region.

Manipulating the colour regions may comprise moving the colour regions within the reference colour space.

Attributes of the colour points of the colour regions may be transformed during the moving of the colour regions, thereby changing the individual colours associated with the respective colour points.

One or more of the colour regions may be defined based on thresholding the fitness values of the respective colour points.

The colour regions and the fitness values of the respective colour points may be created by letting an evaluator arrange the colours in an ordered set from a set of given colors.

The color regions the fitness values of the respective colour points may be created based on fitness values assigned by a number of evaluators.

The mapping unit may extract colours from an image, using manual selection of colours or using image processing techniques, and determines the fitness values of the respective colours.

The mapping unit may display colours associated with a random selection of respective colour points with a selected distance from a specified colour in the reference colour space.

The selected distance from the specified colour in the reference colour space may be adjustable.

The defined colour regions may be saved in a retrievable format for further use.

In accordance with a third aspect of the present invention there is provided a data storage medium having stored thereon computer code means for instructing a computer to execute a method of applying a colour scheme from a source domain to an application domain, wherein the source domain is graphically different from the application domain, the method comprising mapping colours present in the source domain onto a reference colour space; mapping colours present in an object displayable in the application domain onto the reference colour space; defining two or more discontinuous source regions in the reference colour space, the discontinuous source regions approximating a distribution of colours present in the source domain in the reference colour space; defining two or more discontinuous application regions in the reference colour space, the discontinuous application regions approximating a distribution of colours present in the object in the reference colour space; selecting one or more colours from the reference colour space which represent the respective discontinuous source and application regions; varying the colours representing the discontinuous application regions based on the colours representing the discontinuous source regions; and displaying the first object in the application domain utilising the varied colours representing the discontinuous application regions.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1 is a diagram illustrating colour regions in a colour space according to an example embodiment of the present invention.

FIG. 2 is a diagram illustrating the constellation of colours representing a source and an application domain according to an example embodiment of the present invention.

FIG. 3 is a diagram illustrating a source domain, in this case a picture, from which colours, represented as colour points, are extracted according to an example embodiment of the present invention along with the extracted colour scheme.

FIG. 4a is a diagram illustrating a source domain, in this case an image, from which colours, represented as colour points, are extracted according to an example embodiment of the present invention.

FIG. 4b is a diagram illustrating the source domain of FIG. 4a with a reduced number of colours, in this case 6, via an image processing method called colour indexing.

FIG. 4c is a diagram illustrating the set of colour points extracted from the indexed source domain in FIG. 4b according to an example embodiment of the present invention.

FIG. 5 is a diagram illustrating an object in an application domain, in this case a web page, from which colours, represented as colour points, are extracted according to an example embodiment of the present invention.

FIG. 6 is a diagram illustrating the set of colour points extracted from the object of the application domain of FIG. 5, according to an example embodiment of the present invention.

FIG. 7 is a diagram illustrating the changes in an object of an application domain, in this case a web page, brought about by applying colours from the source domain of FIG. 4a, according to an example embodiment of the present invention.

FIG. 8a is an illustration of an object of an application domain in the form of a 3D object, according to an example embodiment of the present invention.

FIG. 8b illustrates the dominant colours representing the object of the application domain of FIG. 8a, according to an example embodiment of the present invention.

FIGS. 9a, 9b, 9c show resultant modified objects of the application domain of FIG. 8a due to application of various image source domains, in this case images also shown, according to an example embodiment of the present invention.

FIG. 10 is a diagram illustrating a colour region in a colour space.

FIG. 11 is a diagram illustrating an order of colours in a colour space.

FIG. 12 is a diagram illustrating a computer program enabling the ordering of colors according to a linguistically defined term.

FIG. 13 is a diagram illustrating the logical operations between colour region.

FIG. 14 is a diagram illustrating the selection of a colour region using colour exploration software.

FIG. 15 shows a schematic diagram illustrating a system for applying a colour scheme from a source domain to an application domain, wherein the source domain is graphically different from the application domain.

FIG. 16 shows a flowchart illustrating a method of applying a colour scheme from a source domain to an application domain, wherein the source domain is graphically different from the application domain.

FIG. 17 illustrates a schematic drawing of a computer system for implementing the method and system according to the example embodiment.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “mapping”, “defining”, “varying”, “displaying”, “moving”, “maintaining”, “determining”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Described here are a method and system that allow the extraction of colour schemes and therefore the related associative emotive content of colour from one domain and application of the colour scheme and the emotive content to a very different domain. Methods are available for the translation of colour from one domain to another where the representation of the object remains similar e.g. translating colour schemes from a picture in the computer screen to a picture of a printout. The method and system described relate to applying colour schemes across vastly dissimilar domains e.g. applying colour schemes from an image to a web page or a computer mouse.

The described method and system can extract and preserve the compositional colour logic of an object displayable in a first domain while applying an entirely different set of colours derived from another, second domain, in displaying a modified version of the object in the first domain. The second domain is referred to as the source domain and the first domain is referred to as the application domain.

One way in which the described method and system preserve compositional colour logic of the object is by mapping the dominant colours of the object to a perceptually uniform space and extracting from the map the constellational information which captures the relative colour differences between the dominant colours. It is believed that by maintaining such a relative colour difference the compositional logic may be maintained while changing the individual colour components—which are derived from the source domain.

It will be appreciated that to evoke an equivalent emotive response it is not necessary to represent all the colours of the source domain and rather that a few dominant colours can be chosen that are representative of the domain. E.g. to evoke the emotive response of a beach it will be appreciated that it is not necessary to represent all the colours that may be found in an image of the beach. Rather, it would be sufficient to represent the emotive response by the typical colours that represent the beach. E.g. some colours of the water, sky and sand. All these colours are different in different beaches and it will be appreciated that the emotive effect is a result of combination of colours rather than the exact representation of the colour.

The mapping of the colours into a perceptually uniform space helps to minimize the errors caused by colour variations as in the perceptually uniform space equal movement in any axis would represent equal error. The quality of the mapping is sensitive to the choice of the representative colours and their ability to evoke the desired colour sentiment.

For example, a selection of colures could also be made from a multiplicity of images of the beach, to choose the typical colours that evoke the sentiment of the beach.

An example embodiment of the present invention advantageously derives a colour scheme from a series of images and applies them to 2D and 3D objects, transferring to these objects the colour sentiment of the source domain.

The colour system used in the example embodiment is based on CIE Lab colour spaces. It is appreciated that colour systems such as RGB and HSB or the like may be used.

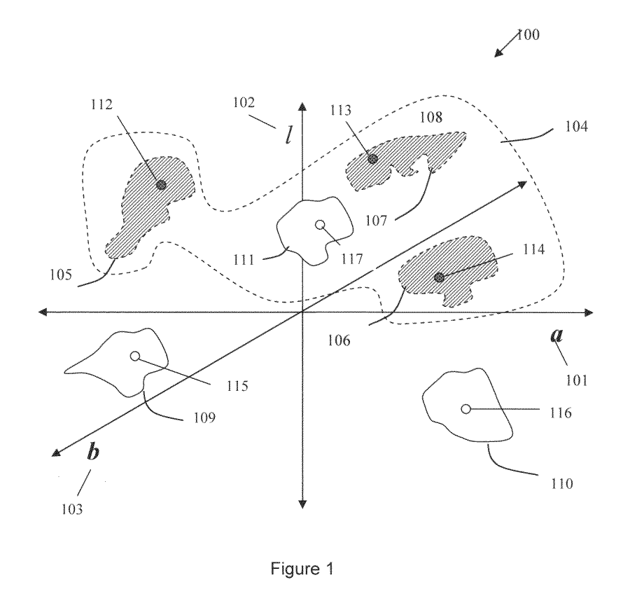

FIG. 1 illustrates a way in which colour regions are defined in the example embodiment.

The colour regions are mapped in the Lab Colour Space 100 defined by a 101, b 103 and l 102 axis. According to the opponent colour theory, the three axes are signified with opposing ends. The l 102 axis ranges from light to dark and the a 101 axis from red to green and the b 103 axis from blue to yellow.

The colours from the source domain are mapped in region 104 and the colours of the object displayable in a sample application domain are mapped in application regions 109,110 and 111. Typically, the colours of the object displayable in the sample application domain are based on a coloured “template” or example of the relevant displayable object. Colour schemes in objects are often composed of a selected number of colours consisting of discrete colour regions. Colour Schemes by their nature are typically made up of a portion of the colour space. If all colours were present in a scheme it will not be seen as a distinct colour scheme. Distinct Colour schemes in the described embodiments are therefore made of colour regions 109, 110 and 111 that are distinctive and placed with sufficient distance from each other. The distinct colours representing the application domains are chosen on the basis of their prevalence in the object displayable in the application domain and on the basis of the different regions they represent in the colour space 100.

Standard image processing techniques such as clustering or indexing may be used to reduce the colour region of the source domain into a number of discrete source regions 105, 106 and 107 that represent the dominant colours. The process of selecting these discrete regions will preferably take into account the distribution of colour in the source domain and the distribution required to achieve both a good spread in the perceptive space and the ability to evoke the intended emotive response from the combination of colours in the source domain.

Due to the nature of colour indexing, which averages out nearby pixels, the resulting colours are sometimes dull and may not include the most perceptually visible colours in the picture. Advanced image processing techniques that detect only perceptually visible patches of colours and techniques that filter out elements that do not contribute to the visual perception of the representative colours may be used to achieve a more accurate extraction of a limited number of colours that induce the closest perceptual response to viewing the source domain in all its colour complexity.

For the ease of mathematical manipulation, the regions 105,106 and 107 may be represented as points 112,113 and 114. Regions 109, 110 and 111 may be represented by points 115,116 and 117. The location of theses representational points may be influenced by the distribution of the colour in the domains.

Representing the source regions 105, 106, 107 or application regions 109, 110, 111, or both, as points facilitates to explore fitting the application regions/points into the source regions/points while allowing some flexibility to find the best match. It is however not to be assumed that the perceptual relevant points of a colour is necessarily at the centre of its colour region. For example, brightness is represented by white, which however has perceptual relevant points at the pole of its colour region. Object colours are signified by an ideal derived from the visible colour variations, rather than the average of visible colour variations.

In the example embodiment, colour schemes can be created by moving the constellation of points of existing colour schemes in the colour space 100. Colour schemes are represented by a fixed constellation of points in the colour space 100. The fixed constellation of points can be moved within the colour space 100 to create alternate colour schemes where the relative differences between the colour elements remain fixed. For example, if a constellation of points for a colour scheme is moved in the direction of the L axis of the Lab space, the colours in the colour scheme may change to become darker or lighter. The constellation of points can also be moved into a different chromatic region where the colours will be entirely different but the relative difference between the colours remains fixed.

Colour schemes can also be created through transformation of the constellation of points of existing colour schemes in the example embodiment. This can be achieved by using mathematical operations. For example, a constellation of points can be expanded or shrunk in the ab or L plane of the Lab space or on both planes. The constellation of points may also be rotated about a user-defined axis.

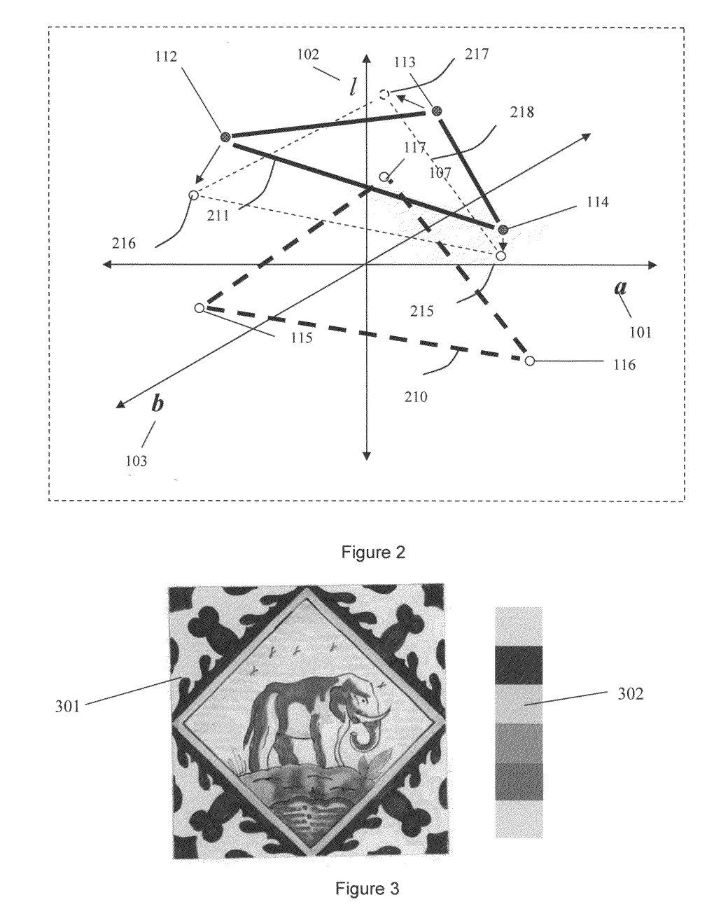

In FIG. 2 the points 112, 113 and 114 representing the source domain are connected by lines 211 illustrating the relative constellational representation of the source domain. The points 115, 116 and 117 representing the object displayable in the application domain are connected by lines 210 illustrating the relative constellational representation of the object in the application domain.

The transformation and translation of the application constellation 210 is shown. The colours 115,116, and 117 of the constellation 210 will be replaced by colours 215,216,217 in the Lab space 100 which are close to colours 114, 113 and 112 in the source domain.

The selection of colours, which could be seen here as the translation of the application constellation 210 towards the source constellation 211, resulting in a translated constellation 218, can have three independent objectives:
1) The application constellation 210 can be moved to best fit the source constellation 211 (this may require the relaxing of the constellational relationship between the application domain)
2) The application domain can be fixed in its constellational relationship 210 (this may resulting sub optimal fit to the source constellation 211).
3) The application constellation 210 can remain close to its original position and move marginally towards the source constellation 211 (one may notice then the application domain being “influenced” by the source domain).

In a graphic composition, colour 116 may for example represent a text colour and colour 117 may represent the background colour. For the text to be readable the relative distance between the points in the a, b and l axis may have to be above a certain value. In such situations, the relative position between the points may have to be maintained while the application constellation 210 is translated to be close to the source constellation 211.

It will be appreciated that not all the colours of the source domain need to be applied to the application domain to elect the desired emotive response. The colour regions of the source domain may be reduced to a larger number of regions than those represented by the application domain, in which case only a selected number of colour regions will be used to transfer the emotive colour content. It will also be appreciated that there is no need to replace all the colour regions of the application domain with colours derived from the source domain.

It will also be appreciated, that while for the purpose of simplification the regions are represented as points, it is possible through the use of mathematical techniques to represent the regions as a collection of points and execute the transfer of colours on the collection of points.

FIG. 3 is a diagram illustrating the source domain as a picture 301 from which colours, represented as colour points, are extracted according to an example embodiment to provide the extracted colour scheme 302. The picture 301, with a reduced number of colours, produces the colour scheme 302 which preserves the emotive aspects of picture 301.

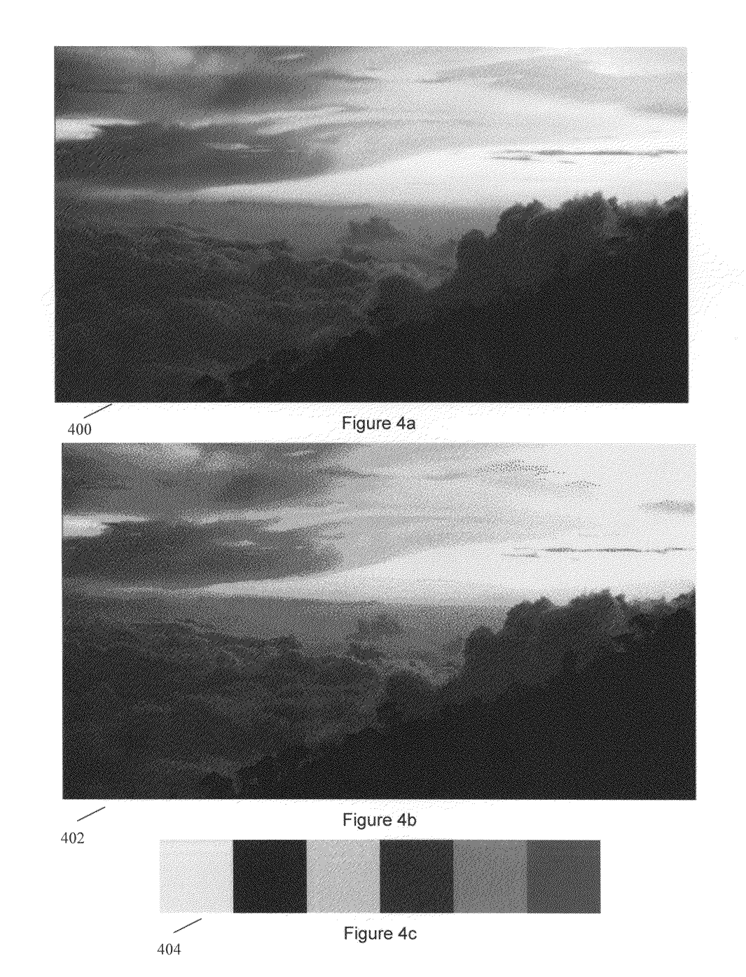

In another example, FIG. 4a shows a source domain as an image 400. The image 400 is reduced to the desired number of colours, in this case six, via an image processing method called colour indexing, resulting in image 402 shown in FIG. 4b. The set of colour points or colour scheme 404 extracted from the indexed source domain (image 402 in FIG. 4b) is shown in FIG. 4c.

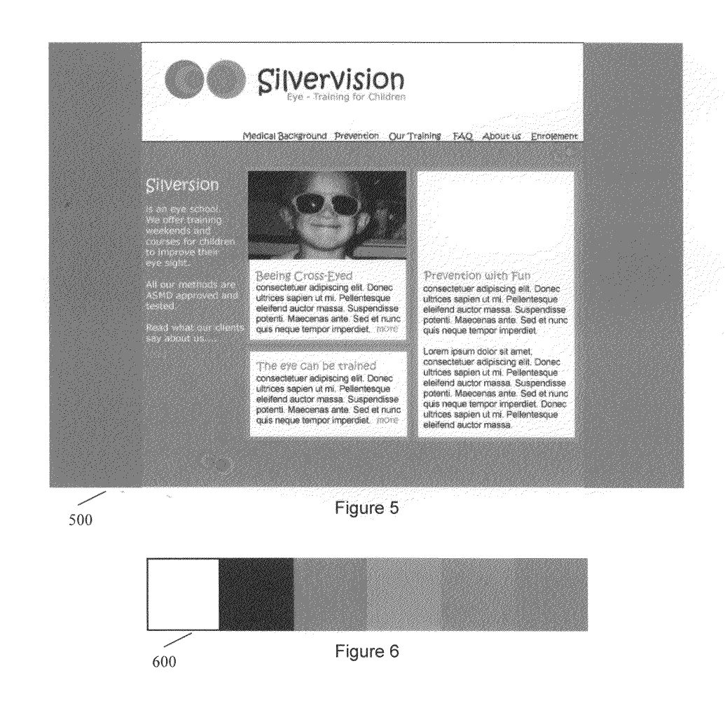

FIG. 5 illustrates an application domain for a web page 500, from which colours represented as colour points or colour scheme 600 are extracted as shown in FIG. 6. The extracted colour points or colour scheme 600 can be used to derive a colour constellation to match colour schemes derived from a plurality of source domains.

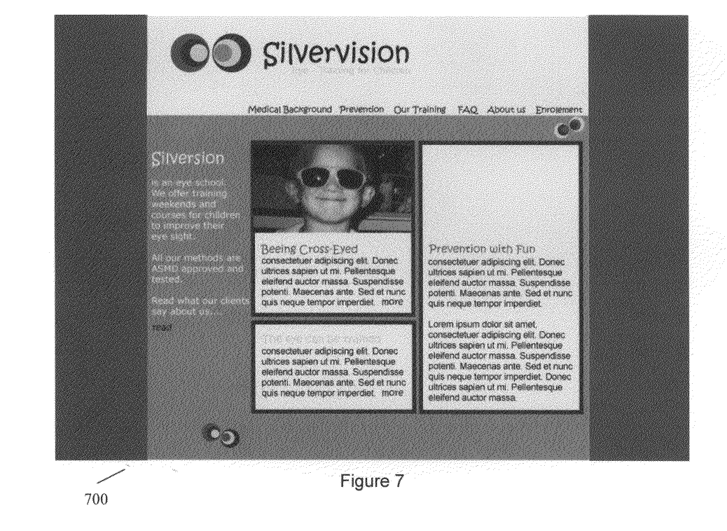

FIG. 7 is a diagram illustrating the changes in the application domain for a modified web page 700 brought about by applying colours from the source domain as image 400 of FIG. 4a to the web page 500 of FIG. 5 according to an example embodiment.

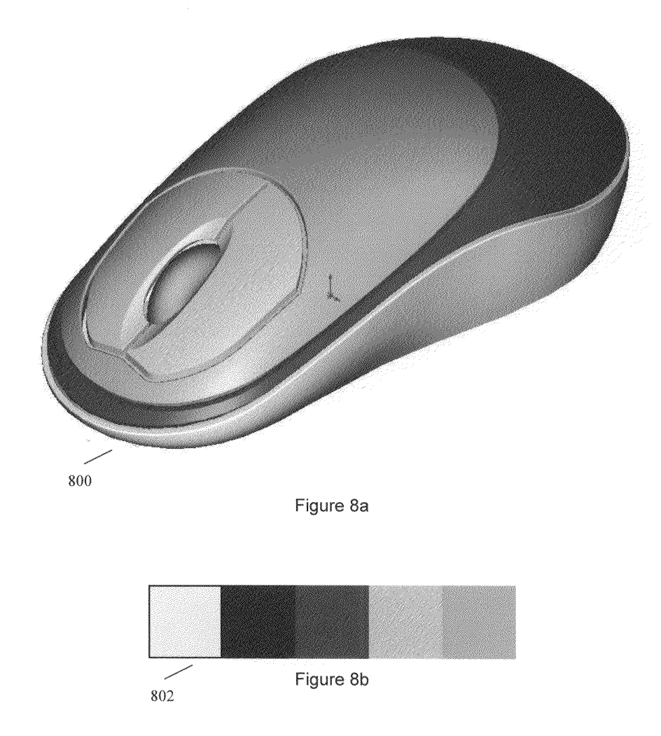

Example embodiments may also be applied to the colouring of 3D objects. FIG. 8a is an application domain for a 3D object 800. FIG. 8b illustrates the colours or colour scheme 802 representing the 3D object 800 in the application domain according to an example embodiment.

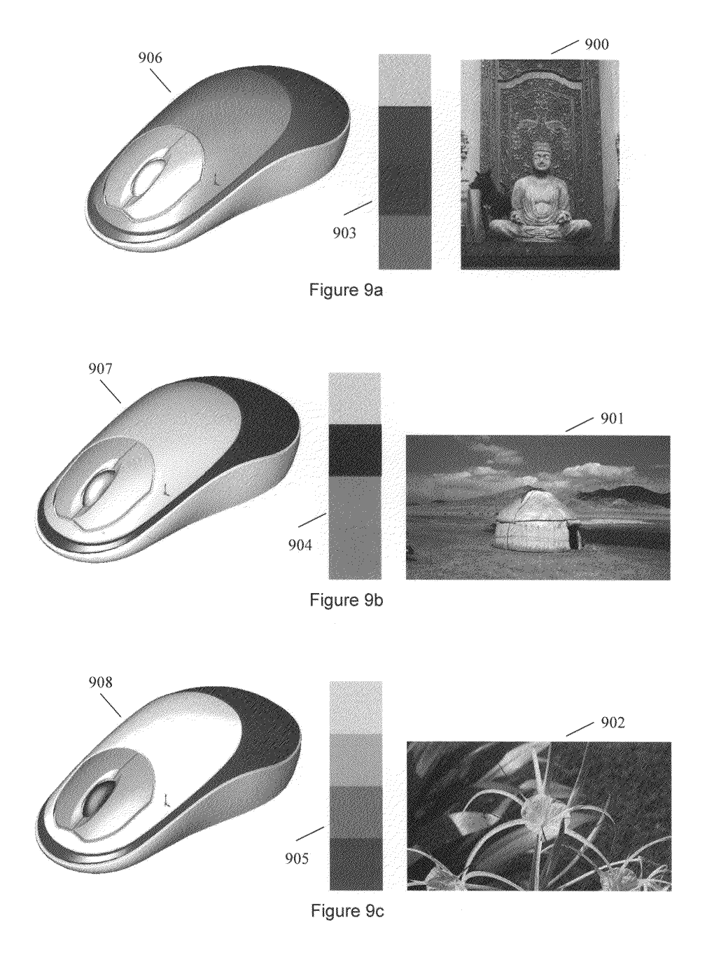

FIGS. 9a to c illustrate how images 900, 901, 902 may be used as source domains to alter the colour content of a 3D object 906, 907, 908 while maintaining the colour logic derived from the 3D object in the application domain (compare colour scheme 802 in FIG. 8b). The colour schemes 903, 904, 905 extracted from the images 900, 901, 902 as source domains are also shown.

It will be appreciated that the various colour schemes 302 (FIG. 3), 404 (FIG. 4c), 600 (FIG. 6), 802 (FIG. 8b), 903 (FIG. 9a), 904 (FIG. 9b) and 905 (FIG. 9c) can be mapped onto a reference colour space such as the Lab colour space 100 (FIG. 1). In other words, each of the respective colour schemes can be represented as a constellation of regions or points, and the transformation processes described above with reference to FIGS. 1 and 2 can be performed to apply a colour scheme from one domain to another domain while maintaining the visual logic or compositional logic of the object to which the colour is applied.

It will be appreciated that factors such as readability create special relationships between adjacent colours to create the necessary contrast, which are preferably maintained for preserving the legibility of the text. This may be achieved by ensuring specific relationships between text and background colours to ensure that conditions for legibility are maintained. While the overall constellational relationships may be maintained, it is understood that certain relationships may be set to have more flexibility than others when the shape of the constellation is modified.

An example embodiment of the present invention advantageously utilises the human mental model of relating colours through human language to provide an intuitive method for colour and colour scheme selection. In such an embodiment, the source domain used is provided based on colour regions defined, manipulated, or both, based on the human mental model of relating colours through human language to capture emotive responses to colour and colour schemes, and to enable manipulation of colours and colour schemes based on imprecise linguistic operators. For example, words can be used to describe colour and various degrees of the colour. Another example involving images is when a person views an image and finds the words to describe it, the image and words and sometimes the emotions evoked by the image and words become associated with the colour of the image viewed.

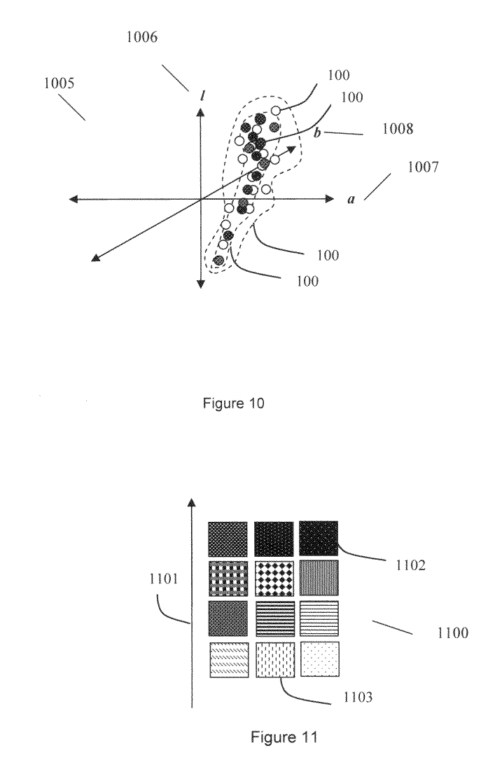

The colour system used in the example embodiment is based on CIE Lab colour spaces. FIG. 10 illustrates a way in which a source domain or colour region is defined in the example embodiment. A colour region 1003 is defined by a pre-assigned collection of points (e.g. points 1000 and 1001) of different values for a particular criterion associated with the region 1003 in a three dimensional Lab space 1005 with axes L 1006, a 1007 and b 1008. According to the opponent colour theory, the three axes are signified with opposing ends. The L axis 1006 ranges from white to black, the a axis 1007 from red to green and the b axis 1008 from blue to yellow.

The values of the points within a region may range from 0 to 1. Points with higher values denote a higher level of fit within the regions: In FIG. 10, point 1000 has value 1 and 1001 has value 0. If the region for “red colour” is to be defined, the red region of the Lab space 1005 will be populated with points with values of 1 or close to 1, and points in the green region of the Lab space 1005 will yield a value of 0 or close to 0. Such a scheme allows the definition of regions and indication of the strength of membership of points (or membership value) within the regions. Depending on the membership value, these regions can be classified using linguistic parameters such as “happy colours” or “natural colours” corresponding to emotive responses conjured by the colours in the colour regions.

The example embodiment provides control over the size of the colour region through the use of threshold values. As an example, regions 1003 and 1004 in FIG. 10 are defined with different threshold values. After creation, region 1003 is defined with a threshold value of 0. All the points within region 1003 are taken to be members of region 1003. When the threshold value is increased, region 1003 will shrink to become region 1004 of a smaller volume, which contains points with membership values higher than the increased threshold value.

FIG. 11 illustrates a way in which membership values are assigned in the example embodiment. In the example embodiment, a colour region represents a region of membership based on a particular criterions. The criterion can be chromatic, emotive or the like. A criterion is represented by linguistic descriptions e.g. Bluish colour, Warm colour or the like.

One or more evaluators are asked to evaluate a series of colours in random order and arrange the colours according to fitness to the pre-defined criterion. As shown in FIG. 11, the best fitting colours e.g. 1102 with richer qualities for the criterion of ‘Bluish colour’ are moved to the top of the axis 1101 whereas the less richer colours e.g. 203 are moved to the bottom of the axis 1101. In the representation shown in FIG. 11, for each row the fitting value increases from left to right, for convenience of representation. The evaluation process may be performed repeatedly as appropriate to further refine the order of colours according to fitness. The colour regions formed as a result of individual criterions, i.e. typically a thresholded subset of the evaluated colour palette 1100, may be combined to form a larger region, which covers a range of colours that fit a more generic description. For example, a larger ‘red colour’ region may comprise smaller ‘dark red’ or ‘bright red’ regions. Similarly, colour regions formed by different individual evaluators may be combined to form a larger representative region for a given criterion.

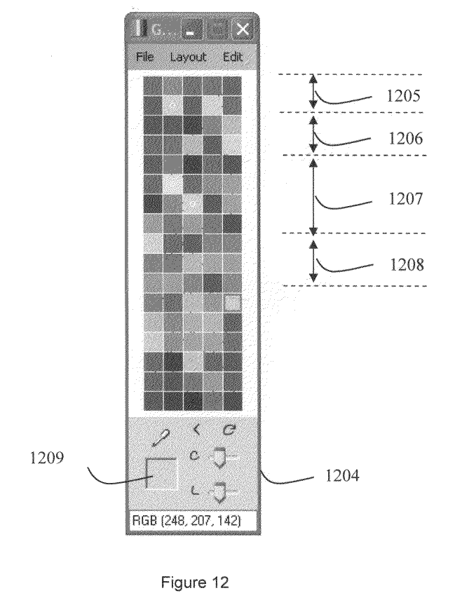

FIG. 12a illustrates the creation of an ordered set of colors representing the term “frutti colours”. Here the a computer program is used to help generate a swatch of colours 1200 around a base colour 1209, which are re-arranged in a way to represent “fruity colours”—with the colours on top of the swatch representing the more fruity colours and the ones at the bottom representing less frutti colours. The region 1205 here represents the “very very fruity” colours with a membership value of 1 and the region 1206 represents the very fruity region with membership value of 0.8 and the region of 1207 represent the fruity colours with a membership of 0.6 and the region 1208 represents the frutiish colors with a membership of 0.3

The exact numerical value set to represent the colour regions is set similar to fuzzy logic where the terms “very very”, “very”, “-ish” and so on are assinged certain values. The evaluators are then asked to arrange or pick the colours that would suit the verbal descriptors of the colour region. Two ways in which the numerical membership values may be set will now be described. One way is to ask the evaluator to split assign the colours to pre-set categories such as “veryfruity”, “fruity”, “fruitiish” and so on. Another way is to ask the evaluator to arrange the colours in the order representing the most fruity colours on top (and right) and the least fruity colours on the bottom (and left) and then using a certain percentile to represent each region.

It is possible to deal with and mathematically define and manipulate imprecise quantities, mainly due to developments in “fuzzy logic”. Fuzzy Logic enables the translation of ill-defined descriptive terms into mathematically definable expressions and also enables linguistic operations on such data. E.g. Once “warm colours” are defined, it would be possible to extract “very warm colours” using fuzzy operations which translate the word “very” into a mathematical operator.

Colour regions may also be discontinuous in a perceptually continuous colour space. For example fashionable colours or trendy colours in year 1986 may form a discontinues region in the colour space. Mathematical operations may be applied for selecting warm and fashionable colours of 1986.

Fuzzy Logic based operations or ordered set based operations enable the translation of linguistic parameters into operations that can effect alteration in a collection of membership values. For example, threshold membership values for colour region “red” can be translated to values corresponding to “very red” through translation operations that respond to the descriptive term “very”. Such operations are useful for shrinking or expanding the colour region as required. For example, with reference to FIG. 10, a translation operation may be used to increase the threshold value of region 1003 to shrink region 1003 to region 1004. Therefore, linguistic operators can be advantageously used to identify or define colour regions in the example embodiment.

Colour manipulation can also be achieved through transformation of the constellation of points of existing colour schemes in the example embodiment. This can be achieved by using mathematical operations. For example, a constellation of points can be expanded or shrunk in the ab or L plane of the Lab space or on both planes. The constellation of points may also be rotated about a user-defined axis. Examples of other possible transformations are
Align points on L level to achieve same brightness
Align points on a and b axis to achieve monochromatic colours
Align points on a radial surface from L axis to create a monochrome colour scheme
Mirroring points about a and b axis to achieve complementary contrast
Mirroring points about any one axis or a combination of axes or about the 50% gray point to achieve other complementary colours
Align points onto a straight line to achieve a colour gradient
Align points onto a continuous curve to achieve a multicolour gradient
Align points onto any surface of a plane to show colour interrelationship
Align colour differences of points to an imaginary centre to achieve a colour circle
Align colour differences of points to one another for triadic, tetradic or the like colour combinations
Align colour differences of points to a grid to achieve uniform multicolour palettes

These operations could also be carried out in combination with linguisticoperators. In the example embodiment, transformation can be activated by linguistic operators working in conjunction with a mathematically interpretionthereof. For example, ‘Make the colour scheme redder’ or ‘Make the colours very serious’ may be applied to transform the location and geometry of a constellation of points accordingly.

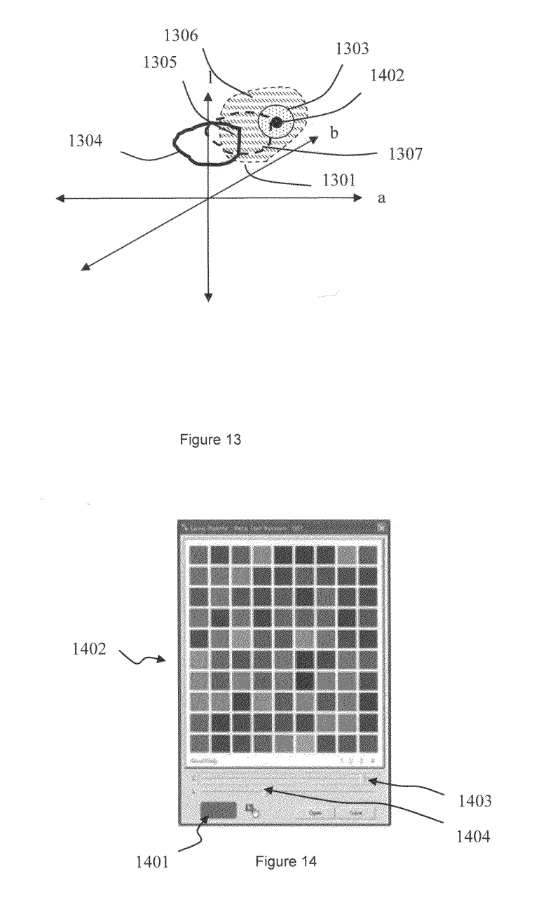

FIG. 13 illustrates some examples of the mathematical operations that may be applied in Lab space to colour regions using conventional mathematical techniques. The region 1301 represents Fruity colours whereas region 1203 may represent reddish colours. Simple mathematical Boolean operations could then be used to define a set of colours 1306 that are fruity and not reddish The region 1304 for example could represent the colour orange, and then the region 1305 would represent the region that is fruity and orange. Geometric regions such as spheres 1303 can also be used to define colour regions around a given colour. If point 1302 was to represent the single colour red, then reddish colours could be represented by the spherical region 1303. The region orange 1304 may be made “redder” by moving it 1307 closer to the region red 1303. This illustrates a way in which regions can be moved towards other regions or points. All types of geometric operations can be performed on the regions by translating verbal instructions to mathematical operations.

FIG. 14 illustrates another computer assisted colour selection and manipulation in an example embodiment. A collection of random colours 1402 is displayed based on a selected colour 1401. The colours 1402 displayed are drawn from a region close to the selected colour 1401 in a perceptually uniform colour space. Such colour exploration software could be used to visually select colour points which can define a desirable region of colour according to a verbal description. The extend of the region may be set by scroll bars 1403 which could regulate chromatic variation and 1404 could regulate the lightness variations that is desired.

Based on the colour selection and manipulation described above with reference to FIGS. 10 to 14, a source domain (compare 104 in FIG. 1), a number discrete source region (compare 105, 106, and 107 in FIG. 1), or both, can be defined. The source domain and the source regions can than be utilised in applying colour scheme from that source domain to application domain.

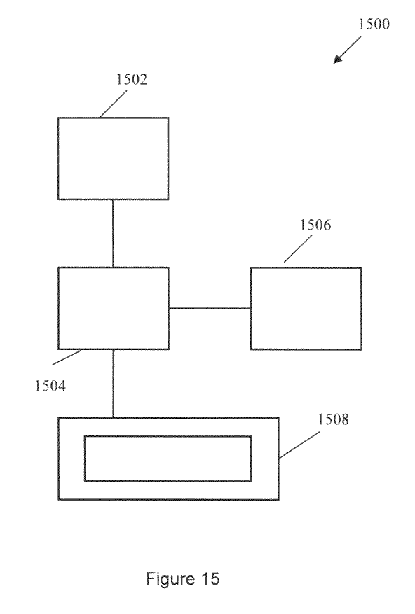

FIG. 15 shows a schematic diagram illustrating a system 1500 for applying a colour scheme from a source domain to an application domain, wherein the source domain is graphically different from the application domain. The system 1500 comprises a mapping unit 15002 for mapping colours present in the source domain onto a reference colour space and for mapping colours present in an object displayable in the application domain onto the reference colour space.

The system 1500 further comprises a processor unit 1504 coupled to the mapping unit 1502 for defining two or more discontinuous source regions in the reference colour space, the discontinuous source regions approximating a distribution of colours present in the source domain in the reference colour space, and for defining two or more discontinuous application regions in the reference colour space, the discontinuous application regions approximating a distribution of colours present in the object in the reference colour space.

The system 1500 further comprises a selector unit 1506 coupled to the processor unit 1504 for selecting one or more colours from the reference colour space which represent the respective discontinuous source and application regions. The processor unit 1504 varies the colours representing the discontinuous application regions based on the colours representing the discontinuous source regions.

The system 1500 further comprises a display unit 1508 coupled to the processor unit 1504 for displaying the first object in the application domain utilising the varied colours representing the discontinuous application regions.

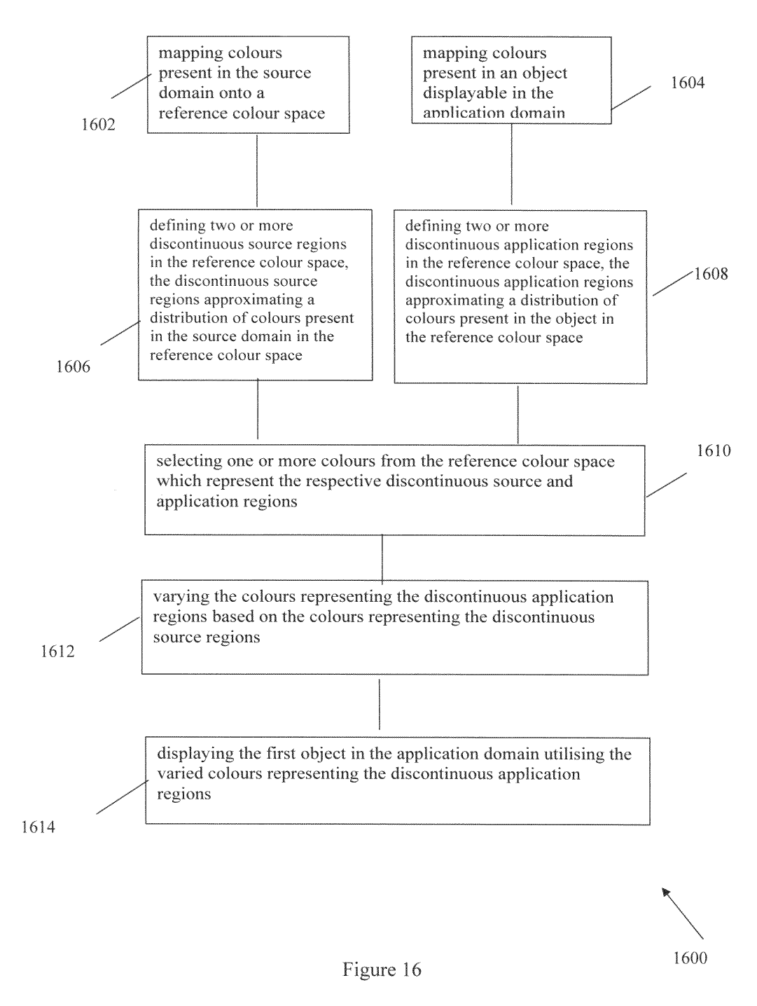

FIG. 16 shows a flowchart 1600 illustrating a method of applying a colour scheme from a source domain to an application domain, wherein the source domain is graphically different from the application domain. At step 1602, colours present in the source domain are mapped onto a reference colour space. At step 1604, colours present in an object displayable in the application domain are mapped onto the reference colour space. At step 1606, two or more discontinuous source regions are defined in the reference colour space, the discontinuous source regions approximating a distribution of colours present in the source domain in the reference colour space.

At step 1608, two or more discontinuous application regions are defined in the reference colour space, the discontinuous application regions approximating a distribution of colours present in the object in the reference colour space. At step 1610, one or more colours are selected from the reference colour space which represent the respective discontinuous source and application regions. At step 1612, the colours representing the discontinuous application regions are varied based on the colours representing the discontinuous source regions. At step 1614, the first object is displayed in the application domain utilising the varied colours representing the discontinuous application regions.

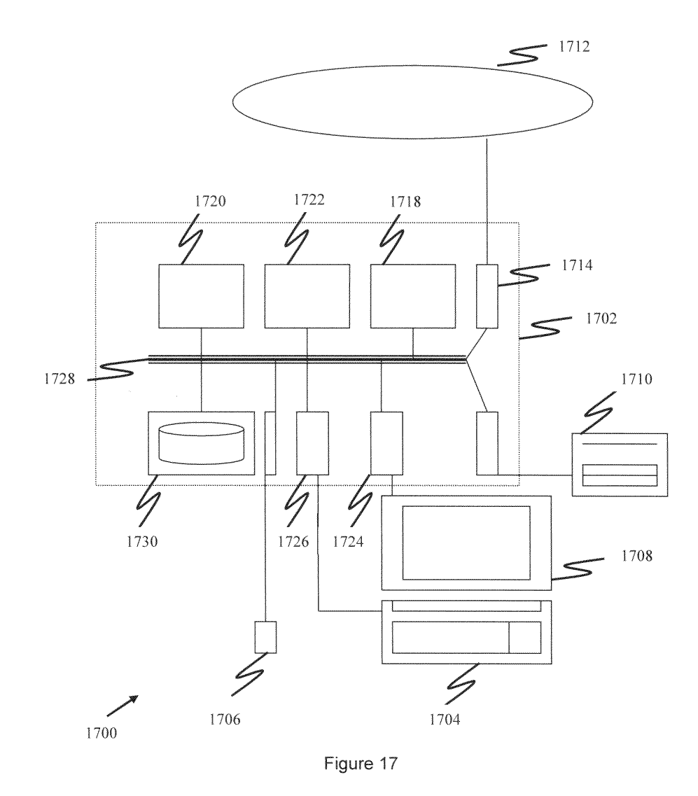

The methods and system described in the example embodiment can be implemented in a computer system 1700, schematically shown in FIG. 17. The procedures may be implemented as software, such as a computer program being executed within the computer system (which can be a palmtop, mobile phone, desktop computer, laptop or the like) 1700, and instructing the computer system 1700 to conduct the method of the example embodiment.

The computer system 1700 comprises a computer module 1702, input modules such as a keyboard 1704 and mouse 1206 and a plurality of output devices such as a display 1708, and printer 1710.

The computer module 1702 is connected to a computer network 1712 via a suitable transceiver device 1714, to enable access to e.g. the Internet or other network systems such as Local Area Network (LAN) or Wide Area Network (WAN).

The computer module 1702 in the example includes a processor 1718, a Random Access Memory (RAM) 1720 and a Read Only Memory (ROM) 1722. The computer module 1702 also includes a number of Input/Output (I/O) interfaces, for example I/O interface 1724 to the display 1708 (or where the display is located at a remote location), and I/O interface 1726 to the keyboard 1704.

The components of the computer module 1702 typically communicate via an interconnected bus 1728 and in a manner known to the person skilled in the relevant art.

The application program is typically supplied to the user of the computer system 1700 encoded on a data storage medium such as a CD-ROM or flash memory device and read utilising a corresponding data storage medium drive of a data storage device 1730. The application program is read and controlled in its execution by the processor 1718. Intermediate storage of program data maybe accomplished using RAM 1720.

Example embodiments of the present invention may have the following features and advantages.

Example embodiments of the present invention simplify the process for colour selection to enrich creative works with colours and enables fast creation of appealing colour schemes. It enables intuitive working on millions of colours rather than working on limited range of colours. Outstanding colour selection results can be achieved by both expert and novice users of example embodiments of the present invention.

Example embodiments of the present invention also enable designers to explore colours with a wide variety of colour selection possibilities through transformation of colour schemes. Colour schemes can be manipulated while maintaining colour relationships. Feedback can be received through linguistic description on the emotive response a colour scheme might evoke. Pre-loaded images are available for creating colour schemes to represent a particular emotive intent easily and quickly. The process for selecting colours for specific emotive responses is simplified.

Other possible applications of the example embodiments include use in image manipulation (e.g. a filter to harmonize a colour scheme), use in alteration of a colour scheme such that an object appears in a different colour, use as an image search engine (e.g. to search image stocks or search the internet for images), or use in image compression.

Pictures present inherently complex colour schemes which are difficult to achieve by picking and choosing from a standard palate of colours. By using pictures to derive colour schemes complex and rich colour schemes can be achieved. It has been noted that if the picture represents a natural scene the colours derived from it form a colour scheme that is harmonious and pleasing to the eye.

Many modifications and other embodiments can be made to the method and system by those skilled in the art having the understanding of the above described disclosure together with the drawings. Therefore, it is to be understood that the device and its utility is not to be limited to the above description contained herein only, and that possible modifications are to be included in the claims of the disclosure.

1. A method of applying a colour scheme from a source domain to an application domain, wherein the source domain is graphically different from the application domain, the method comprising:
mapping colours present in the source domain onto a reference colour space;
mapping colours present in an object displayable in the application domain onto the reference colour space;
defining two or more discontinuous source regions in the reference colour space, the discontinuous source regions approximating a distribution of colours present in the source domain in the reference colour space;
defining two or more discontinuous application regions in the reference colour space, the discontinuous application regions approximating a distribution of colours present in the object in the reference colour space;
selecting one or more colours from the reference colour space which represent the respective discontinuous source and application regions;
varying the colours representing the discontinuous application regions based on the colours representing the discontinuous source regions; and
displaying the first object in the application domain utilising the varied colours representing the discontinuous application regions.

2. The method as claimed in claim 1, further comprising the step of moving the discontinuous source or application regions, or both, in the reference colour space prior to selecting the colours representing the respective discontinuous source or application regions, or both.

3. The method as claimed in claim 2, wherein the moving of the discontinuous source or application regions, or both, is based on technical colour manipulation commands or mathematically interpreted linguistic colour manipulation commands.

4. The method as claimed in claim 1, wherein the varying of the colours representing the discontinuous application regions based on the colours representing the discontinuous source regions is also based on the distribution of colour in the source or application domain, or both.

5. The method as claimed in claim 1, wherein the reference colour space comprises a perceptionally continuous colour space.

6. The method as claimed in claim 5, wherein the perceptionally continuous colour space comprises CIE Lab colour space.

7. The method as claimed in claim 1, further comprising determining respective interrelationships between the different discontinuous source regions and between the different discontinuous application regions.

8. The method as claimed in claim 7, further comprising manipulating said interrelationships.

9. The method as claimed in claim 8, wherein the manipulating of said interrelationships comprises one or more of a group consisting of expanding, contracting, elongating, translating and scaling.

10. The method as claimed in claim 7, further comprising storing said interrelationships.

11. The method as claimed in claim 1, further comprising mapping colours present in respective ones of a plurality of source domains onto the reference colour space and defining two or more discontinuous source regions in the reference colour space, the discontinuous source regions approximating a distribution of the colours present in the plurality of source domains in the reference colour space.

12. The method as claimed in claim 1, wherein relative positions of some of the discontinuous source regions are maintained while relative positions of others of the discontinuous source regions are relaxed in the reference plane.

13. The method as claimed in claim 1, further comprising deciding to either adhere strictly to relative positions of the discontinuous application regions or to relax the relative positions of the discontinuous application regions in order to achieve a closer chromatic representation of the source domain.

14. The method as claimed in claim 1, wherein the mapping of colours present in the source domain onto the reference colour space comprises defining one or more colour regions in the reference colour space based on fitness values of respective color points with regard to a criterion and manipulating the colour regions according to mathematical operations associated with imprecise linguistic operators.

15. The method as claimed in claim 14, wherein manipulating the colour regions comprises manipulating a size, a shape, or both of the colour region.

16. The method as claimed in claim 14, wherein manipulating the colour regions comprises moving the colour regions within the reference colour space.

17. The method as claimed in claim 16, wherein attributes of the colour points of the colour regions are transformed during the moving of the colour regions, thereby changing the individual colours associated with the respective colour points.

18. The method as claimed in claim 14, wherein one or more of the colour regions are defined based on thresholding the fitness values of the respective colour points.

19. The method as claimed in claim 14, wherein the colour regions and the fitness values of the respective colour points are created by letting an evaluator arrange the colours in an ordered set from a set of given colors.

20. The method as claimed in claim 19, wherein the color regions the fitness values of the respective colour points are created based on fitness values assigned by a number of evaluators.

21. The method as claimed in claim 14, further comprising extracting colours from an image, using manual selection of colours or using image processing techniques, and determining the fitness values of the respective colours.

22. The method as claimed in claim 14, further comprising displaying colours associated with a random selection of respective colour points with a selected distance from a specified colour in the reference colour space.

23. The method as claimed in claim 22, wherein the selected distance from the specified colour in the reference colour space is adjustable.

24. The method as claimed in claim 14, wherein the defined colour regions are saved in a retrievable format for further use.

25. A system for applying a colour scheme from a source domain to an application domain, wherein the source domain is graphically different from the application domain, the system comprising:
a mapping unit for mapping colours present in the source domain onto a reference colour space and for mapping colours present in an object displayable in the application domain onto the reference colour space;
a processor unit for defining two or more discontinuous source regions in the reference colour space, the discontinuous source regions approximating a distribution of colours present in the source domain in the reference colour space, and for defining two or more discontinuous application regions in the reference colour space, the discontinuous application regions approximating a distribution of colours present in the object in the reference colour space;
a selector unit for selecting one or more colours from the reference colour space which represent the respective discontinuous source and application regions;
wherein the processor unit varies the colours representing the discontinuous application regions based on the colours representing the discontinuous source regions; and
a display unit for displaying the first object in the application domain utilising the varied colours representing the discontinuous application regions.

26. The system as claimed in claim 25, wherein the processor unit moves the discontinuous source or application regions, or both, in the reference colour space prior to the selector unit selecting the colours representing the respective discontinuous source or application regions, or both.

27. The system as claimed in claim 26, wherein the moving of the discontinuous source or application regions, or both, is based on technical colour manipulation commands or mathematically interpreted linguistic colour manipulation commands.

28. The system as claimed in claim 25, wherein the varying of the colours representing the discontinuous application regions based on the colours representing the discontinuous source regions is also based on the distribution of colour in the source or application domain, or both.

29. The system as claimed in claim 25, wherein the reference colour space comprises a perceptionally continuous colour space.

30. The system as claimed in claim 29, wherein the perceptionally continuous colour space comprises CIE Lab colour space.

31. The system as claimed in any claim 25, wherein the processor unit further determines respective interrelationships between the different discontinuous source regions and between the different discontinuous application regions.

32. The system as claimed in claim 31, wherein the processor unit manipulates said interrelationships.

33. The system as claimed in claim 32, wherein the manipulating of said interrelationships comprises one or more of a group consisting of expanding, contracting, elongating, translating and scaling.

34. The system as claimed in claim 31, further comprising a database for storing said interrelationships.

35. The system as claimed in claim 25, wherein the mapping unit maps colours present in respective ones of a plurality of source domains onto the reference colour space and the processor unit defines two or more discontinuous source regions in the reference colour space, the discontinuous source regions approximating a distribution of the colours present in the plurality of source domains in the reference colour space.

36. The system as claimed in claim 25, wherein the processor unit maintains relative positions of some of the discontinuous source regions while relaxing relative positions of others of the discontinuous source regions in the reference plane.

37. The system as claimed in claim 25, wherein the processor unit operates either in a state of adhering strictly to relative positions of the discontinuous application regions or in a state of relaxing the relative positions of the discontinuous application regions in order to achieve a closer chromatic representation of the source domain.

38. The system as claimed in claim 25, wherein the mapping of colours present in the source domain onto the reference colour space comprises defining one or more colour regions in the reference colour space based on fitness values of respective color points with regard to a criterion and manipulating the colour regions according to mathematical operations associated with imprecise linguistic operators.

39. The system as claimed in claim 38, wherein manipulating the colour regions comprises manipulating a size, a shape, or both of the colour region.

40. The system as claimed in claim 38, wherein manipulating the colour regions comprises moving the colour regions within the reference colour space.

41. The system as claimed in claim 40, wherein attributes of the colour points of the colour regions are transformed during the moving of the colour regions, thereby changing the individual colours associated with the respective colour points.

42. The system as claimed in claim 38, wherein one or more of the colour regions are defined based on thresholding the fitness values of the respective colour points.

43. The system as claimed in claim 38, wherein the colour regions and the fitness values of the respective colour points are created by letting an evaluator arrange the colours in an ordered set from a set of given colors.

44. The system as claimed in claim 43, wherein the color regions the fitness values of the respective colour points are created based on fitness values assigned by a number of evaluators.

45. The system as claimed in claim 38, wherein the mapping unit extracts colours from an image, using manual selection of colours or using image processing techniques, and determines the fitness values of the respective colours.

46. The system as claimed in claim 38, wherein the mapping unit displays colours associated with a random selection of respective colour points with a selected distance from a specified colour in the reference colour space.

47. The system as claimed in claim 46, wherein the selected distance from the specified colour in the reference colour space is adjustable.

48. The system as claimed in claim 38, wherein the defined colour regions are saved in a retrievable format for further use.

49. A data storage medium having stored thereon computer code means for instructing a computer to execute a method of applying a colour scheme from a source domain to an application domain, wherein the source domain is graphically different from the application domain, the method comprising:
mapping colours present in the source domain onto a reference colour space;
mapping colours present in an object displayable in the application domain onto the reference colour space;
defining two or more discontinuous source regions in the reference colour space, the discontinuous source regions approximating a distribution of colours present in the source domain in the reference colour space;
defining two or more discontinuous application regions in the reference colour space, the discontinuous application regions approximating a distribution of colours present in the object in the reference colour space;
selecting one or more colours from the reference colour space which represent the respective discontinuous source and application regions;
varying the colours representing the discontinuous application regions based on the colours representing the discontinuous source regions; and
displaying the first object in the application domain utilising the varied colours representing the discontinuous application regions.
